(19) United States
(12) Patent Application Publication
(10) Pub. No.: US 2013/0013530 A1
(43) Pub. Date: Jan. 10, 2013

(54) Method and System for measuring decisions of a portfolio manager as it relates to the return performance for any given asset

(76) Inventor: David J. Nowacki, Dallas, TX (US)

(21) Appl. No.: 13/177,066

(22) Filed: Jul. 6, 2011

(51) Int. Cl. G06Q 40/06

(52) U.S. Cl. 705/36 R

(57) ABSTRACT

The present invention relates to a method and system for measuring a portfolio manager's decisions and performance for any asset as it relates to and compares to the potential performance which might have occurred during any given finite time period. An asset (which example is intended to be illustrative and not restrictive) can be a single publicly traded stock, bond, option, commodity, real asset or real estate, a portfolio of assets, or an index. Investment performance can target an individual action or actions of a portfolio manager or a financial institution's actions (which example is intended to be illustrative and not restrictive) such as a mutual fund, hedge fund, public or private pension fund.

### FIELD OF THE INVENTION

The present invention relates to a method and system for measuring investment performance of any portfolio manager and for any asset as compared to the possible investment performance that asset could have realized for any given time frame selected for such comparisons. The present invention will measure the timing of the investment decision to quantify what value that investment decision created. Such decision by the portfolio manager will be compared to all other finite decisions resulting from all other possible timings which could have been realized in the same period.

The present invention may utilize standard and non-standard statistical tools in evaluating the portfolio manager's decisions compared to the possible decisions which could have been made and create a mechanism by which decisions, such as portfolio management activities, can be evaluated, ranked and analyzed so as to quantify and value what was contributed to the portfolio returns resulting from the portfolio manager's decisions.

In one example (which example is intended to be illustrative and not restrictive), the method and system may be used for measuring investment performance when a portfolio manager purchases an asset and sells an asset in a given time period (i.e., buys IBM stock in May and sells in August) and compares that decision will all other finite decisions which could have been made during the time period selected by the using of this invention (i.e., buy IBM in January and sell in May).

In one example (which example is intended to be illustrative and not restrictive), the method and system may be used for measuring a portfolio manager's actions or decisions for any given individual asset or any asset comprised of two or more assets, where an asset can mean a single item or an asset can mean a portfolio of items.

### BACKGROUND OF THE INVENTION

Asset returns are a function of trade entry prices, trade exit prices, transaction or other costs associated with the assets and cash flows created by the asset while owned, all coupled with the time and timing of such activities. Trade entry price means the asset value when an initial transaction takes place. This can mean being “long the asset” or owning the asset as well as ‘being short the asset’ or shorting the asset as an initial transaction. While the remainder of the background will focus on buying an asset, selling an asset short or ‘shorting’ assets is also considered in this invention even though largely excluded from examples in the remainder of this discussion.

The initial action involving an asset can be considered a binary decision at any given moment in time: one can ‘buy’ or one can ‘not buy’. Once the decision to buy an asset has been made, the return analysis begins. For any given ending time period, like the end of a calendar month, quarter or year, an analysis can take place concerning the purchase price of that asset, net of all costs, cash generated by that asset during the time frame between the ending period and ownership of the asset, costs associated with the ownership of the asset and the ending value of the asset on the day the period ends.

The asset's rate of return or investment return, sometime referred to as a holding period return, can be calculated once the data (cash outflows, cash inflows and the ending value) is identified. Many times the holding period return is converted to an annual return, annualized or modified to show an annual return. The annual return is generally used to compare assets across various asset classifications.

Before this invention, the analysis of a portfolio manager's action was based on an overall return for their decisions and comparisons of their realized returns to some market index.

This invention quantifies how efficient and effective a portfolio manager can be when executing transactions. This invention is a system and method to compare a portfolio manager's decision against all other decisions which that manager could have been made. For one example, an investor may purchase of a stock on a specific Tuesday, thus creating the trade entry point. However, what return might have been realized if that transaction occurred, say, the day before, the day after, or a week later? Moreover, what were the returns from an exit trade occurring the day before, the day after or a week later? Last, how does the actual return realized by the portfolio manager compare to all the other possible combinations of the initial and terminal actions of that asset for that given time period?

This invention quantifies the value added a portfolio manager's decision created by comparing the return realized by that portfolio manager for the specific dates of their transactions against all possible returns which could have been realized. As one example, an investor could have realized a return of “X %” by buying the asset in March and selling that asset in November. The comparison may choose an annual time frame for comparison and monthly frequencies of data. Thereby, a possible investment data set could have been: buy the asset in January and sell in October. All possible data sets, using a one year time horizon and monthly frequencies of data will be analyzed.

One analysis might compare the annualized return earned by the portfolio manager for a given asset against the average return from all the monthly data points. The calculation of annualized returns for the portfolio manager's actions is straight forward. Monthly data points could mean collecting closing prices for month end on the data then analyzing all possible buy and sell combinations using these monthly data points. A January asset buy could be following with a sale using February, March and all other trailing months. A February asset buy could be followed with a sale using the March, April and all remaining trailing months. The number of outcomes is based on the following formula, where “n” is the frequency selected:

$$\frac{n ( n + 1 )}{2}$$

For frequency on a quarterly basis, there will be 10 possible investment outcomes. For a monthly basis, the possible outcomes create 78 data points; weekly frequencies create 1,378 data points.

Using the monthly data points, an average for all possible 78 outcomes is calculated. This average outcome can be considered a “naïve” outcome . . . that is, randomly selected entry and exit points. The actual return of the portfolio manager is compared to the average of all possible returns. In this example, a simple above/below comparison implies if a portfolio manager's decision contributed to the realized return of the asset.

Assets in this invention are designated as any individual asset or collection of assets, sometimes referred to as a single portfolio or even portfolios. Portfolios have returns calculated by aggregating individual asset returns of those assets within the given portfolio. Many times such portfolios are evaluated on both the return realized by the assets contained within, the volatility of the return and compared to other portfolio returns such as an indexed portfolio.

Investors seeking to purchase assets such as stocks or bonds seek to determine if an asset or portfolio has produced a reasonable return and if future events will produce similar results. Similarly, many hire professional, such as portfolio managers, to act on their behalf; however, current systems and methods of evaluation do not allow for the measurement of the professional's actual decision and what contributions, if any, a portfolio manager truly provides to asset under management. This present invention provides a method and system which can quantify if a portfolio manager is creating returns for assets managed.

Returns for individual assets and for portfolio of assets are based on decisions portfolio managers make throughout a given time period, including the decision to do nothing. Assets are exchanged (bought/sold) in discreet, finite transactions. Since asset returns are based on decisions made by portfolio managers in discreet transactions, there can exist information as to whether a portfolio manager is adding value through increasing the asset's return by their decision making; more specifically, the timing of a portfolio manager's decision. Is today's decision to buy the asset a better decision than making such decision yesterday or tomorrow?

This invention evaluates how an investor's decision (timing) ranks will all possible decisions the investor could have made. For illustrative purposes, assume in our example that there are 5 discreet trading days (only) for an asset, the price of the asset can change at will (perhaps randomly but in discreet changes) during any given trading day, the asset has a definite end-of-day value, and the investor can buy the asset during any day, at any time and holds the asset at the end of the time in question. The holding period return is that return using the initial purchase price and the ending value, where we assume no transaction costs, no holding costs and no cash being disbursed by the asset.

Using the illustrative example above, this invention would calculate the holding period returns for all possible holding periods. Using only the ‘end-of-day’ prices, holding period returns are originated from;
buying day one and selling: day two, or day three, or day four, or day five (where end of day five is identical to owning at the end of the period
buying day two and selling: day three, day four or day five
buying day three and selling: day four or day five
buying day four and selling day five
(note: if short selling were allowed in this example, possible returns would double).

There are 10 possible or potential returns which could have been earned by the example. These possible returns, resulting from the possible decisions that could have been made, are compared to the actual return earned by the investor. Results could show the investors decision produced a higher return than the averages of all possible returns. Results could also show that, on average, the decision (timing) to purchase the asset during the time in question was less than average; that is, guessing a time to execute the trade would have produced, on average, a better return for the asset.

Whether on an individual asset basis or in aggregate, this invention will determine if and when a portfolio manager adds value to asset returns upon executing trades when compared to all possible trade execution events. In a larger picture, data produced from such analyzes will be able to rank investors by their decision abilities more specifically than comparing their portfolio's return with that of an indexed portfolio. In addition, individuals with cash balances can use this tool as an indicator of how portfolio managers have performed in past efforts when buying or selling assets.

### DETAILED DESCRIPTION OF THE INVENTION

Detailed embodiments of the present invention are disclosed herein; however, it is to be understood that the disclosed embodiments are merely illustrations of the invention and that the present invention may be embodied in various forms. In addition, each of the examples given in connection with the various embodiments of the invention is intended to be illustrative, and not restrictive. Further, calculations provided in examples may take liberties with calculating returns such as using 360-day year versus a 365/366 day year. The results of some calculations are provided although the actual calculation is not provided in detail here. Additionally, calculations may or may not include bad days such as a day of maturity falling on a weekend. And such assumptions may or may not be included in the application of this invention. Therefore, specific structural and functional details disclosed herein are not to be interpreted as limiting, but merely as a representative basis for teaching one skilled in the art to variously employ the present invention.

Of note, the application contains material that is subject to copyright protection. The copyright owner has no objection to the facsimile reproduction by anyone of the copyrighted material, as it appears in the Patent and Trademark Office file or records, but otherwise reserves all copyright rights whatsoever.

In one embodiment of the present invention there is provided a method of measuring the return or investment performance by any portfolio manager using any asset, be it a single asset or one or more assets combined into an investment portfolio. This return for the asset or portfolio of assets is compared to all possible returns which could have been achieved during the time frame and frequency within that time frame selected by the user of this invention.

This invention will directly measure, by comparison to all possible outcomes, what a portfolio manager's decision accomplished as it pertains to their realized return. As one example (which example is intended to be illustrative and not restrictive), a portfolio manager decided to buy an asset on January 27 of a given year and held that asset until the end of the year. The Holding Period will be defined as the time frame the portfolio manager bought the asset and either sold it, or at the end of the time frame in question (that is, continuing to own the asset at the end of the time frame). The purchase price including costs of acquisition, ending value of the asset including any costs associated with liquidation, holding costs for the time of ownership, dividends or any cash received from the asset determine the Holding Period Return. This specific holding period return is compared with all other potential holding period returns for that given year.

Some Holding Period Returns (which example is intended to be illustrative and not restrictive) might be:

buying in January 26 and holding to the end of the year;
buying on January 28 and holding to the end of the year;
buying on January 26 and holding until December 28 of that year.

The actual Holding Period Return of the portfolio manager is compared to all holding period returns, which time frame and frequency is defined by the user of this invention. A set of data is created for that asset using all combinations of potential Holding Period Returns.

The present invention can be applied (which example is intended to be illustrative and not restrictive) to monthly returns, weekly returns or daily returns. Comparisons of the portfolio manager's Holding Period Return (HPR) to the various potential returns can include (which example is intended to be illustrative and not restrictive): average HPR for all possible returns versus that of the Portfolio Manager, variance of returns over time, mean, median, mode analysis along with any number of other statistical analysis applied to this period, multi-period and multi-Portfolio Managers.

In this way, a benchmark may be provided which allows others to evaluate how a portfolio manager added value or not, through the timing of their decisions. For instance, the benchmark may utilize an average decision, based on an average return of all available returns and compares such average to that of the portfolio manager's HPR. This simple comparison may determine what impact the portfolio manager's decision and/or asset allocation decisions have had on investment portfolio performance, in general, and in comparison to other asset returns, other portfolio manager selections or indexes.

Further, in this regard, the portfolio manager can be compared to a similar group of portfolio managers creating a peer group. Any member of the peer group or groups can be compared to other members including developing a ranking system. For example (which example is intended to be illustrative and not restrictive), the portfolio manager's peer group may comprise of other portfolio managers having substantially similar portfolios or may include an entire universe of assets included in any given portfolio, including single assets evaluations.

In another example (which example is intended to be illustrative and not restrictive), the portfolio manager's peer group may comprise of portfolios which has requirements where assets cannot be shorted or using short sales. In another example (which example is intended to be illustrative and not restrictive), the portfolio manager's peer group may comprise of other managers classified as active portfolio managers, passive portfolio managers using any number of indexes, synthetic positions using any type of derivative securities or derivative assets.

In another example (which example is intended to be illustrative and not restrictive), the portfolio manager's peer group may comprise Portfolio Managers using periods greater than one day, one year or multiple years. In another example (which example is intended to be illustrative and not restrictive), the portfolio manager's peer group may comprise other portfolio managers who participate in dissimilar markets, similar markets or the ability to change markets at anytime. In this regard, it is noted that a portfolio manager may place part or all of the assets in cash or cash equivalents, then slowly or abruptly move from this position to some other asset or set of assets. Then at some later date, the Portfolio Manager can slowly or abruptly move, in whole or in part, from the asset or portfolio of assets into other assets, including cash or cash equivalents. The system covers all alternatives in the asset selection and includes all decisions and timing of decisions.

In another example (which example is intended to be illustrative and not restrictive), this invention allows for comparisons of dissimilar assets such a as bonds versus stocks, individual stock versus stock indexes, stock portfolios versus stock index portfolios, assets classified as commodities.

In another example (which example is intended to be illustrative and not restrictive), this invention allows for comparisons of dissimilar time frames such as quarterly holding period returns, monthly returns, annual or multi-year returns and the use of differing time frames with the analysis such as a single asset's holding period return of 7 months as compared to a 12-month holding period return for a stock index.

In another example (which example is intended to be illustrative and not restrictive), this invention allows for comparisons of dissimilar styles and constrictions shorting such as a portfolio of assets like a hedge fund which may be allowed to short assets (sell short assets and later buying the asset to cover the short position) versus a stock index or other indexes.

In another example (which example is intended to be illustrative and not restrictive), this invention allows for comparisons of averaging an asset return versus actual return such as comparing a 6 month holding period return with the annual return of a stock index, the average holding period return of the stock index or the entire spectrum of returns which could have been earned by the asset and/or the asset being compared.

In another example (which example is intended to be illustrative and not restrictive), this invention allows for comparisons of portfolio performance versus an accumulation of actual assets which allows for an Portfolio Manager to make additional transactions in an asset (additional purchases, sales, or other trading activities, including hedging) throughout the designated holding period. The invention allows for an analysis of each activity and all activities as a whole.

In another example (which example is intended to be illustrative and not restrictive), this invention allows for comparisons of actual assets in lieu of portfolio performance which allows for an analysis of individual components, an analysis for the aggregate decisions of the individual components or any combination therein.

In another example (which example is intended to be illustrative and not restrictive), any portfolio manager's results may be aggregated with other portfolio manager's results, including indexes, to create a relative position in the peer group based on investment portfolio performance over the predetermined period(s) of time. This comparison may be in the form of ranking, percentile or any other reporting mechanisms which will compare and contrast decision results.

As discussed herein, the present invention may provide a mechanism to assist a person to evaluate a portfolio manager's decision making abilities in managing assets through timing of buy/sell transactions to usefully ascertain how this portfolio manager compares to an average decision and those of any peer group (this analysis may extend, for example, to a comparison of the Portfolio Manager return versus what could have been earned had the Portfolio Manager done nothing or taking more steps.

This invention allows for the user of the system to determine the time frame they desire for evaluation purposes. In one example, (which example is intended to be illustrative and not restrictive), a portfolio manager's total holding period can be 6 months while that data used to compare this investment decision can be based on 6 months or longer and can have daily (using daily closing prices), weekly (using weekly closing prices), monthly (using monthly closing prices) or quarterly data (using quarterly closing prices).

Referring now to the accompanying tables, details on how this present invention develops data to be used to evaluate the performance of specific Portfolio Managers is provided.

Any and all examples provided are intended to be illustrative and not restrictive including the use of the results as it pertains to developing statistical evidence on a portfolio manager's decisions as it pertains to adding value through their decision-making processes.

Referring now to Table 1, data is collected from a portfolio manager. In this example, Portfolio Manager “X” and Portfolio Manager “Y” will be evaluated and each invests in one asset only. The invention gives broad allowances for the inclusion or exclusion of data. As one example (which is intended to be illustrative and not restrictive), the data may incorporate transactions costs such as commissions or fees or such data may be omitted. The data provided shows identical actions by Portfolio Manager “X” and Portfolio Manager “Y” in that both buy asset “A” then later sell it. This can be termed “going long the asset” initially, then selling the asset at a later date. However, the difference between the two portfolio managers is that the timing of both the purchase and the later sale is not identical. An annualized return is calculating by using a standard initial amount of investment, credit for having idle funds in money market accounts pre- and post transaction and any gain or loss from taking the position in the asset.

TABLE 1
Manager Trades for Asset “A”

| | Portfolio Manager | Portfolio Manager |
|---|---|---|
| | “X” | “Y” |
| Purchase Date | 2/15/2010 | 4/15/2010 |
| Purchase Price | $14.25 | $16.25 |
| Sale Date | 11/20/2010 | 9/30/2010 |
| Sales Price | $18.5 | $17.00 |
| Annual Return (*) | 31.05% | 6.29% |

(*) $100 beginning balance per position and a 4% Money Market rate of return for any idle cash in any period.

Referring to Table 2, this table outlines the time frame and frequency selected by the user of this invention. Given such selections, the data is collected on the Asset “A”, used by both Portfolio Managers to be evaluated along with data from another Asset “M” and a selected index. Table 2 shows the time frame selected is the calendar year from Jan. 1, 2010 thru Dec. 31, 2010; additionally, the frequency selected is on a quarterly basis. Users of this present invention are allowed to determine the length or duration of the analysis and the frequency of the intervals. Daily, weekly, monthly or quarterly data can be used in this analysis. The use of more frequent intervals will create more data points and a larger population for comparison purposes. Lastly, the present invention allows comparisons to multiple other assets. Table 2 shows the quarterly data for Asset “A”, Portfolio “M”, an Index and reports what money market rates were during the time periods in question.

TABLE 2
Reported Data on Various Assets
Selected Time Frame = 1 calendar year;
Jan. 1, 2010 to Dec. 31, 2010
Selected Frequency = Quarterly Data
Reported Data

| Quarter | Price of “A | Asset “M” | Index |
|---|---|---|---|
| Beginning of Year | $15 | $325 | $30 |
| End of Qtr 1 | $14 | $345 | $31 |
| End of Qtr 2 | $18 | $365 | $32 |
| End of Qtr 3 | $17 | $355 | $29 |
| End of Year | $20 | $360 | $32 |

Table 3 will be comprised of two sub-tables “3a” and ‘3b”. Referring to Table 3a., a listing of the possible trading events are given as defined by the selected time frame and frequency. Table 3a. shows the various potential holding periods which could have been realized for the selected time frame. Using quarterly numbers, an investment opportunity can begin at the beginning of the year and held for that entire year. Another opportunity is to own the asset at the beginning of a given year and sell it at the end of the first, second or third quarters. For any asset owned at the beginning of the year, 4 separate opportunities (or exit points) can be realized. Similarly, an asset purchased at the end of Quarter 1 can have an exit or sale at the end of the second, third or fourth quarter. The number of possible return opportunities is finite, once the frequency is selected. The number of outcomes is based on the following formula, where “n” is the frequency selected:

$$\frac{n ( n + 1 )}{2}$$

For frequency on a quarterly basis, there will be 10 possible investment outcomes. For a monthly basis, the possible outcomes create 78 data points; weekly frequencies create 1,378 data points.

TABLE 3 a
Possible Trading Events using Selected
Time Frame and Selected Frequency

| Date of | Date of |
|---|---|
| Purchase | Sale |
| Begin Yr | Qtr 1 |
| Begin Yr | Qtr 2 |
| Begin Yr | Qtr 3 |
| Begin Yr | End of Yr |
| Qtr 1 | Qtr 2 |
| Qtr 1 | Qtr 3 |
| Qtr 1 | End of Yr |
| Qtr 2 | Qtr 3 |
| Qtr 2 | End of Yr |
| Qtr 3 | End of Yr |

Users of this invention may select any frequency of reporting. Using weekly closing prices, 1,378 data points will create a data base. The distribution of such data can be analyzed and compared to a portfolio manager's actual return. Users of this invention can determine how many data points, resulting from the frequency selected, constitutes robust results.

Referring to Table 3b., the Holding Period Return (“HPR”) for asset “A”, asset “M” and the “Index” are shown in respect to the given potential timing. Within this table, you will see that the HPR for asset “A”, asset “M” and the “Index, given all are purchased at the end of Quarter I and later sold at the end of Quarter III is 21.4%, 2.9%, −6.5%, respectively.

Additionally, Table 3b. provides just a few statistical calculations (which is intended to be illustrative and not restrictive) which include the average HPR, standard deviation and high and low HPR's for each asset given.

TABLE 3b
Possible Returns for Time Frame and
Frequency Selected

| | | | Holding | Holding | |
|---|---|---|---|---|---|
| | | | Period | Period | Holding |
| | | | Return | Return | Period |
| | | | (HPR) | (HPR) | Return |
| Date of | Date of | | Asset | Portfolio | (HPR) |
| Purchase | Sale | | “A” | “M” | Index |
| Begin Yr | Qtr 1 | | −6.7% | 6.2% | 3.3% |
| Begin Yr | Qtr 2 | | 20.0% | 12.3% | 6.7% |
| Begin Yr | Qtr 3 | | 13.3% | 9.2% | −3.3% |
| Begin Yr | End of Yr | | 33.3% | 10.8% | 6.7% |
| Qtr 1 | Qtr 2 | | 28.6% | 5.8% | 3.2% |
| Qtr 1 | Qtr 3 | | 21.4% | 2.9% | −6.5% |
| Qtr 1 | End of Yr | | 42.9% | 4.3% | 3.2% |
| Qtr 2 | Qtr 3 | | −5.6% | −2.7% | −9.4% |
| Qtr 2 | End of Yr | | 11.1% | −1.4% | 0.0% |
| Qtr 3 | End of Yr | | 6.9% | 0.3% | 3.8% |
| | | Avg | 16.5% | 4.8% | 0.8% |
| | | Median | 16.7% | 5.1% | 3.2% |
| | | Std | | | |
| | | Dev | 0.160 | 0.051 | 0.055 |
| | | Range | | | |
| | | Hi | 42.9% | 12.3% | 6.7% |
| | | Range | | | |
| | | Lo | −6.7% | −2.7% | −9.4% |

Referring to Table 4, the data previous used in Table 3 is incorporated into an active money market accounts when not invested. As one example, owning the asset at the beginning of the time period and through to the end of the time period will have no added funds due to the money market growth as there were not idle times. Another example is to have no activity until the second quarter, then the asset is purchased and held through to the end of the time period. Under this opportunity, money market earnings will accrue on the investment from the beginning period until the asset is purchased. Another example has money market earnings during all idle times including beginning and end periods. Table 4 shows the holding period return for all assets shown.

TABLE 4
Returns using Money Market Returns on any Idle Asset (only “A” provided here)
Asset “A” Data Only

| | | | | | | | APR |
|---|---|---|---|---|---|---|---|
| | | | | | | | Adjusted |
| | | Basic | | | | | for Cash |
| Purchase | Sale | HPR | Qtr 1 | Qtr 2 | Qtr 3 | End | Invested |
| Begin Yr | Qtr 1 | −6.7% | | $94.27 | $95.21 | $96.16 | −3.84% |
| Begin Yr | Qtr 2 | 20.0% | | | $121.20 | $122.41 | 22.41% |
| Begin Yr | Qtr 3 | 13.3% | | | | $114.47 | 14.47% |
| Begin Yr | End of Yr | 33.3% | | | | | 33.3% |
| Qtr 1 | Qtr 2 | 28.6% | $101.00 | $129.86 | $131.16 | $132.47 | 32.47% |
| Qtr 1 | Qtr 3 | 21.4% | $101.00 | | $122.64 | $123.87 | 23.87% |
| Qtr 1 | End of Yr | 42.9% | $101.00 | | | $144.29 | 44.29% |
| Qtr 2 | Qtr 3 | −5.6% | $101.00 | $102.01 | $96.34 | $97.31 | −2.69% |
| Qtr 2 | End of Yr | 11.1% | $101.00 | $102.01 | | $113.34 | 13.34% |
| Qtr 3 | End of Yr | 6.9% | $101.00 | $102.01 | $103.03 | $110.16 | 10.16% |
| | | | | | | Avg | 18.78% |
| | | | | | | St Dev | 15.58% |
| | | | | | | Range Hi | 44.29% |
| | | | | | | Range Lo | −3.84% |

Several notes are required concerning Tables 1 through Tables 4. The present invention allows for Portfolio Manager data to be day/date specific (reference Table 1) while the comparable assets use periodic day/dates. The present invention allows for inclusion or exclusion of incremental costs, to include but not limited to, commissions associated with purchase and sales, carrying costs or storage costs for some commodities and any other costs or benefits such as dividend yield associated with any assets used in the analysis. The present invention allows for estimations of money market income instead of actual calculations. Furthermore, this invention recognizes that portfolio manager's decisions may not always be made at prices at the end of the day, week, month, quarter or year. However, the allowance of utilizing actual portfolio manager's data, for example trading at intra-day prices, can give portfolio managers an advantage in the data.

Referring to Table 5, Ranked Data Points and Preliminary Data Comparisons are provided (which example is intended to be illustrative and not restrictive). Some basic and preliminary statistical calculations can be made on both Portfolio Manager “X” and Portfolio Manager “Y” given their actual returns on asset “A”, the returns that the specific asset could have earned, given the time frame and frequency selected in the analysis, the return on any other asset (such as those provided in Tables 1 through 5, namely Portfolio “M”, Index and any other considered asset). Additionally, statistical analysis can be applied to the data returns included inferences based on distributions of the data generated by the actual data and data points generated from what could have been achieved.

One item in Table 5 has ranked the data from the lowest HPR to the highest HPR.

One example can compare the actual return of Portfolio Manager “X” and Portfolio Manager “Y” compared with that of the entire Asset “A's” possible return. Here, Portfolio Manager “X” shows a 31% return which when compared to all Asset “A's” possible returns, is highly ranked. That is, there is only 2 decision points with higher overall returns (holding the asset all year and purchasing asset “A” at the end of Quarter 1 and holding it until the end of the year). Portfolio Manager “X” comparison indicates the Portfolio Manager's decision was better than an average decision and better than an average return. It might be implied Portfolio Manager “X” has added value in the decision process. Similarly, Portfolio Manager “Y” is compared to all the opportunities which could have been realized. Portfolio Manager “Y's” return of 6% is only superior to 4 out of the 10 possible outcomes. In addition, Y's return is below an average decision and the average return. It might be implied that “Y's” investment decisions destroyed value versus making an average purchase and sale decision.

In a continuation of the example above, the Portfolio Managers can now be ranked among other Portfolio Manager data.

Additionally, data from Portfolio “M” can be used to compare that portfolio's potential return with that of Portfolio Manager “X”, Portfolio Manager “Y”, Asset “A”, and the Index. Such comparison can include, but not limited to, average decisions, average yields, variance of returns, the distribution of data characteristics, rankings and more.

TABLE 5
Ranked Data Points and Preliminary Data Comparisons
Ranked Data points

| HPR Basic | Avg | St Dev | Lo | | | | | | | | | Hi |
|---|---|---|---|---|---|---|---|---|---|---|---|---|
| Asset “A” | 16.5% | 16.0% | −6.7% | −5.6% | 6.9% | 11.1% | 13.3% | 20.0% | 21.4% | 28.6% | 33.3% | 42.9% |
| Portfolio “M” | 4.8% | 5.1% | −2.7% | −1.4% | 0.3% | 2.9% | 4.3% | 5.8% | 6.2% | 9.2% | 10.8% | 12.3% |
| Index | 0.8% | 5.5% | −9.4% | −6.5% | −3.3% | 0.0% | 3.2% | 3.2% | 3.3% | 3.8% | 6.7% | 6.7% |
| Portfolio | | | | | | | | | | | 31.1% | |
| Manager “X” | | | | | | | | | | | | |
| Portfolio | | | | 6.3% | | | | | | | | |
| Manager “Y” | | | | | | | | | | | | |

This invention allows for the application of any and all comparisons, statistical analysis, and rankings upon actual return data, data generated by the potential returns and differing frequency selections. Only a very limited number of standardized statistical tools have been provided in Table 5 or any other table. These few examples are intended to be of a limited illustrative purpose and not restrictive as to what analytics might be applied to a situation where actual portfolio manager returns are compared with the finite number of possible returns this invention targets.

What is claimed is:

1. A method and system which compares the investment return of an asset earned by a portfolio manager against all possible investment returns that asset could have earned for the given time frame selected in the comparison. The time frame is a variable selected by the user of this invention, which includes the overall length of time for the analysis and the frequency studied within the selected length of time such as an annual analysis with monthly frequency intervals (which examples are intended to be illustrative and not restrictive). The method and system will evaluate permutations of asset ownership for the frequency selected and the given time frame selected to calculate all possible investment outcomes and investment returns which could have been realized. These permutations of possible returns create a data base or distribution of data. The investment return of the portfolio manager can be compared to this data's distribution of potential returns of this asset or may include comparisons of returns on other assets or combinations of other assets. The method and system will evaluate, explicitly and implicitly, the decisions of the portfolio manager or their actions and how these actual events or actions compare to potential other actions the portfolio manager could have taken. The method and system allows for statistical analysis to be conducted, for comparison purposes, utilizing data generated within this analysis and data generated from external sources, such as indexes (which example is intended to be illustrative and not restrictive).

2. The method and system of claim one can utilize manual mathematical calculations or utilized computerized calculations and includes any software designed, created or adapted to perform such calculations.

3. The method and system of claim one designates an asset as any real or current or past asset or any derivative of an asset or any fictitious asset. A real asset (which example is intended to be illustrative and not restrictive) can be a publicly or privately traded stock, bond, gold bullion, real estate or tangible assets. A current real asset (which example is intended to be illustrative and not restrictive) can be an asset which is currently available in the world. A past asset (which example is intended to be illustrative and not restrictive) can be an asset which might have been available in the past such as a publicly traded stock existing a decade ago or any historical data from any asset. A derivative can be any asset which derives its price from another asset. A fictitious asset is any asset where pricing data is created, synthesized or adopted from other data for the purposes of training, testing, gaming or otherwise created by hand, computer or through algorithms (which example is intended to be illustrative and not restrictive).

4. The method and system of claim one also describes a portfolio of assets as being a single asset. The method and system of claim one can analyze the return of a portfolio whereby individual assets comprising that portfolio or a collections of portfolios within the portfolio can also be analyzed. A portfolio (which example is intended to be illustrative and not restrictive) can be comprised of cash, cash equivalents or money market account which can be converted, in whole or in part, into another asset, such as a stock or a portfolio can be comprised of sub-portfolios such as investment grade bond portfolio, municipal bond portfolio, cash equivalents, blue chip stock portfolio or options portfolio. In addition, segregating assets or aggregating assets into a collection of assets or portfolios where the collective decisions produce a return and such return can be compared with the collective potential of all possible decisions, in aggregate.

5. The method and system of claim one includes short selling transactions incorporating margin accounts and any and all requirements pertaining to such short selling transactions, such as margin requirements (which example is intended to be illustrative and not restrictive).

6. The method and system of claim one incorporates a portfolio manager to be any individual, a collection of individuals, manager or managers of securities portfolios, teams of individuals or managers who manage funds, such as mutual fund, pension fund, financial institution, student or students, trainee and hedge fund manager or managers (which example is intended to be illustrative and not restrictive).

7. The method and system of claim one defines a portfolio manager's actions or resulting events to be a decision or set of decisions by which the portfolio manager executed or enacted. The decision or set of decisions defines the events or actions of that portfolio manager leading to the actual return that portfolio manager earned on the given asset, for the given time frame. The method and system evaluates how the actual decision or set of decisions compares with the possible decisions which could have been made. The method and system of claim one can utilize an averaging of all decisions of a portfolio manager for an asset over a given time period or keep separate each asset decision.

8. The method and system of claim three includes creating a simulation of asset pricing which can then be used for evaluation purposes. Simulation of asset pricing can mean the creation of raw data from any number of sources such as random number generators, algorithms or historical pricing data (which example is intended to be illustrative and not restrictive). Such simulated asset pricing applies to gaming activities, training activities or any activity where actual decisions are to be compared with possible outcomes and/or other individuals or groups of individuals.

9. The method and system of claim one includes any and all time frames selected for any analysis. Specifically, (which example is intended to be illustrative and not restrictive), an asset whose purchased in February and sold in August, can be compared to such asset purchase ranging from January to December of that same year. The method and system can be used to span a period more than one year, one year or less than one year with the data frequency reported to be monthly data, weekly data, or daily data (which example is intended to be illustrative and not restrictive).

10. The method and system of claim nine includes the option of including any costs or cash flows generated by cash or cash equivalent positions, assets distributions such as dividends or coupon payments (which example is intended to be illustrative and not restrictive), and any returns from cash or cash equivalent payments after a sale. Transactions costs can be included or excluded as costs associated with the potential of returns from a given asset.

11. The method and system of claim one includes the ability to utilize externally secured data in comparing an investor's return with all possible turn such as a common stock index, bond index or other industry comparable standards (which example is intended to be illustrative and not restrictive).

12. The method and system of claim one includes the ability to use or apply any and all statistical models to compare and contrast a portfolio manager's generated return. Additionally, the portfolio manager's returns can be compared with the potential returns and/or externally generated returns or index data, and used to determine whether the portfolio manager's returns were a direct or an indirect result of their decisions and to what extent returns were created by random events including luck (which example is intended to be illustrative and not restrictive).

13. The method and system of claim one includes a portfolio manager's actions which include buying, selling or doing neither such as holding a current position indefinitely; non-actions such as not purchasing or not selling an owned asset can be included as an investor action, over any time period and any frequency to be used.
